(19) United States
(12) Patent Application Publication
(10) Pub. No.: US 2004/0194144 A1
(43) Pub. Date: Sep. 30, 2004

(54) Method for asynchronously watching programs from the internet and the system thereof

(76) Inventors: Chi-Tai Lin, Taipei (TW); Chang-Tai Yu, Yi-Lan City (TW); Yi-Liang Ting, Taipei City (TW); Chao-Wei Sung, Taipei City (TW)

Correspondence Address: SUPREME PATENT SERVICES, POST OFFICE BOX 2339, SARATOGA, CA, 95070, US

(21) Appl. No.: 10/397,716

(22) Filed: Mar. 25, 2003

(51) Int. Cl. H04N 7/173

(52) U.S. Cl. 725/110; 725/109; 725/112

(57) ABSTRACT

A method for asynchronously watching programs from internet includes providing at least one IP address in connection to the internet, receiving a user's end connection through the at least one IP address, transmitting the corresponding program to the user's end over the at least one IP address, receiving the user's end connection to the random visual communication server, receiving command package to the random visual communication server from the user's end, processing the command package by the random visual communication server, the user's end requesting connection to the video program broadcasting server, receiving programs of the video program broadcasting server through the IP address, sending command package from the user's end to the video program broadcasting server, receiving responses from the video program broadcasting server after sending the command package, and playing the visual programs as randomly selected.

### FIELD OF THE INVENTION

The present invention relates to a method for asynchronously watching programs from the internet, and also relates to a system enabling the user to randomly control the playing of a program from the internet.

### BACKGROUND OF THE INVENTION

Nowadays, the introduction of internet provides a great deal of convenience to the users. Users are able to remote-control on/off of the domestic electrical appliance simply by sending commands through t ie internet. However, when viewing a cable program, the user can not do anything to the program. Because there is no any connection between the user end and the cable program provider, the only thing the user can do to a program is to preset a recorder to record the program, otherwise, the user can not pause, fast-forward, fast-rearward, stop or even replay the playing of the cable program.

To overcome the shortcomings, the present invention intends to provide a method for asynchronously viewing programs from the internet and the system thereof to mitigate or obviate the aforementioned problems.

### SUMMARY OF THE INVENTION

The primary objective of the invention is to provide an improved method for asynchronously viewing programs from the internet and the system thereof such that the user is able to control the playing of a program from the internet.

In order to accomplish the foregoing objective, the system of the present invention includes a video program broadcasting server, a random visual communication server and multiple user's ends electronic devices. The method includes:

providing at least one IP address in connection to the internet, wherein the at least one IP address represents corresponding programs;

receiving a user's end connection through the at least one IP address; and

transmitting the corresponding programs through the at least one IP address to the user's end; and

The method also include:

receiving the user's end connection to the random visual communication server;

receiving command package to the random visual communication server from the user's end; and

processing the command package by the random visual communication server;

Still, the method has the following steps:

the user's end requesting connection to the video program broadcasting server;

receiving programs of the video program broadcasting server through the IP address;

the user's end playing the received programs;

sending command package from the user's end to the random visual communication server;

receiving responses from the video program broadcasting server after sending the command package; and

playing the visual programs as randomly selected.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the structure of the invention, wherein the system includes a video program broadcasting server, a random visual communication server, and multiple user's end electronic devices;

FIG. 2A is a schematic view showing that the video program broadcasting server includes at least one IP address

FIG. 2B is a schematic view showing the structure of the random visual communication server;

FIG. 2C is a schematic view showing the structure of the user's end electronic device;

FIG. 3A is a flow chart showing the steps in the video program broadcasting server;

FIG. 3B is a flow chart showing the steps in the random visual communication server;

FIG. 3C is a flow chart showing the steps in the user's end electronic device;

FIG. 4 is a schematic view showing the structure of the random visual command package; and

FIG. 5 is a schematic view showing the operation of the user's end electronic device.

### DETAILED DESCRIPTION OF THE INVENTION

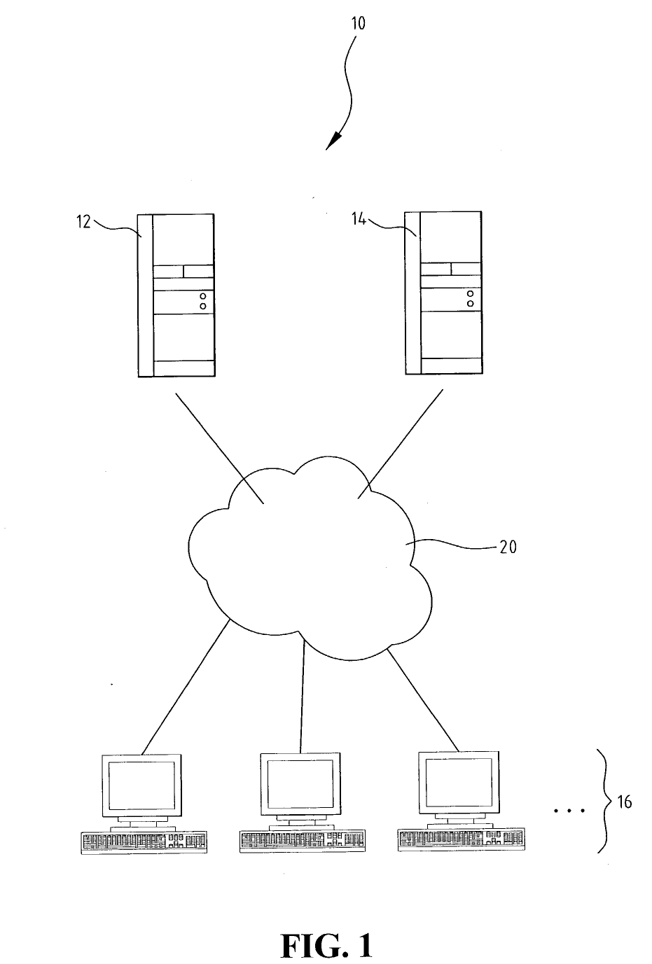

With reference to FIG. 1, the system 10 for asynchronously viewing programs from the internet includes a video program broadcasting server 12, a random visual communication server 14, multiple user's end electronic devices 16 and internet 20 for interconnecting the video program broadcasting server 12, the random visual communication server 14 and the multiple user's end electronic devices 16.

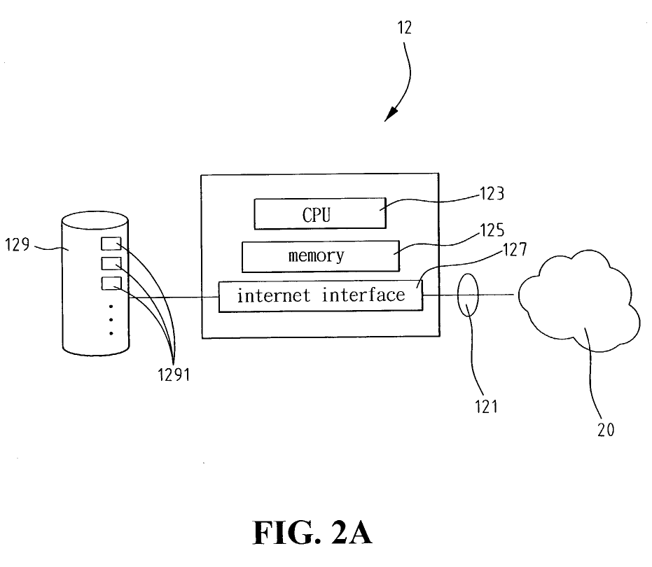

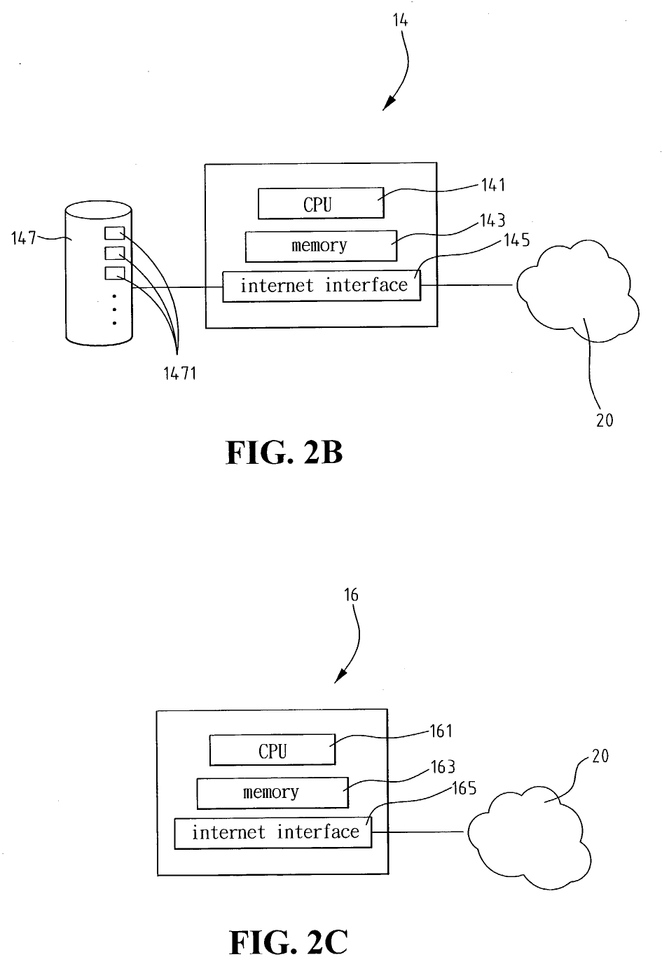

With reference to FIG. 2A, the video program broadcasting server 12 includes at least one IP (internet protocol) address 121 connected to the internet 20. The at least one IP address 121 represents corresponding video programs, e.g. x0.x1.x2.x3 represents the video programs in channel 39 and y0.y1.y2.y3. represents the video programs in channel 40. A central processing unit 123 is able to process program codes stored in a memory 125. The program codes enable the video program broadcasting server 12 to receive the connection from the user's end electronic devices 16 through the IP address 121 and retrieve sequentially program 1291 from a program bank 129 and then transmit the retrieved programs to the user's end electronic devices 16. An internet interface 127 enables the video program broadcasting server 12 to connect to the internet 20.

With reference to FIG. 2B, the random visual communication server 14 includes a central processing unit 141 which is able to process the program codes stored in a memory 143 so that the random visual communication server 14 is able to receive, process and respond to a command package 70 from the user's end electronic devices 16. A video program bank 147 is used to store multiple randomly selected video program 1471. An internet interface 145 enables the random visual communication server 14 to connect to the internet 20.

The video program 1291 in the program broadcasting server 12 and transmitted through the IP address 121 and the video program 1471 randomly selected are made in bit stream form.

With reference to FIG. 2C, the user's end electronic device 16 is composed of a central processing unit 161 enabling to process the program codes stored in the memory 163, an internet interface 165 enabling the user's end electronic device 16 to connect to the internet 20, wherein the user's end electronic device 16 is a personal computer (PC) or a set top box, etc.

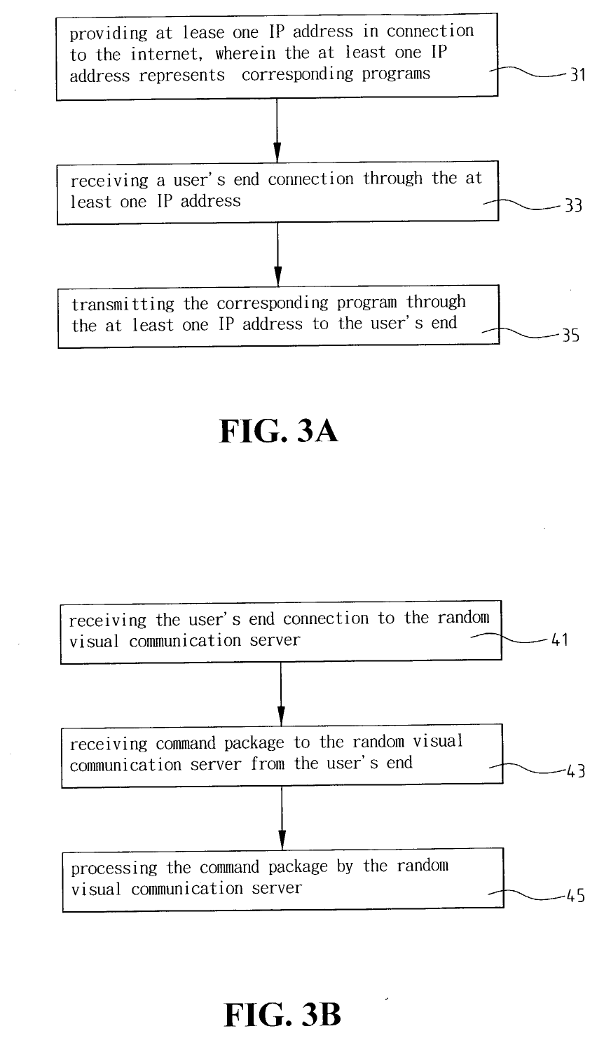

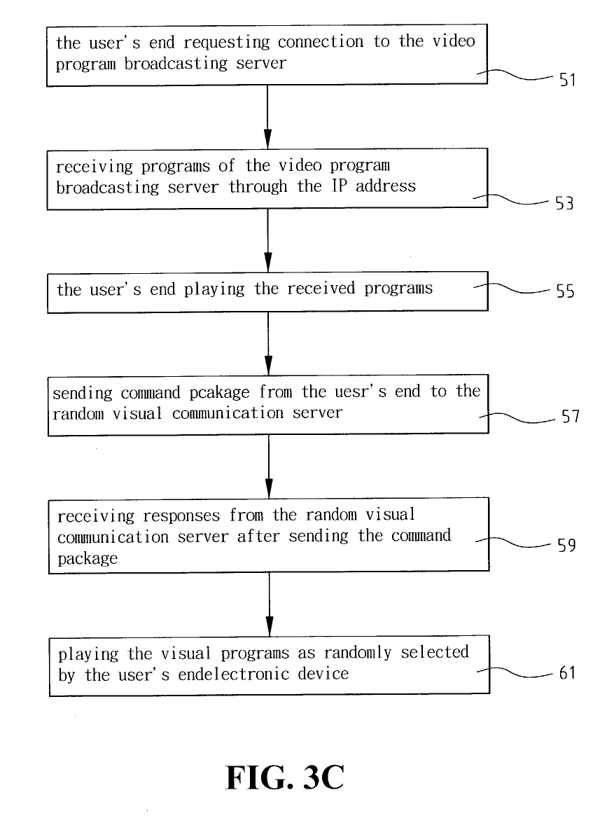

The method of the present invention includes the steps in FIG. 3A, which are the steps in the program broadcasting server, wherein the steps comprises:

31, providing at least one IP address in connection to the internet, wherein the at least one IP address represents corresponding programs;

33, receiving a user's end connection through the at least one IP address; and

35, transmitting the corresponding programs through the at least one IP address to the user's end.

FIG. 3B shows the steps in the random visual communication server, which has:

41, receiving the user's end connection to the random visual communication server;

43, receiving command package to the random visual communication server from the user's end; and

45, processing the command package by the random visual communication server.

FIG. 3C shows the steps in the user's end electronic device, which includes:

51, the user's end requesting connection to he video program broadcasting server;

53, receiving programs of the video program broadcasting server through the IP address;

55, the user's end playing the received programs;

57, sending command package from the user's end to the random visual communication server;

59, receiving responses from the random visual communication server after sending the command package; and

61, playing the visual programs as randomly selected by the user's end electronic device.

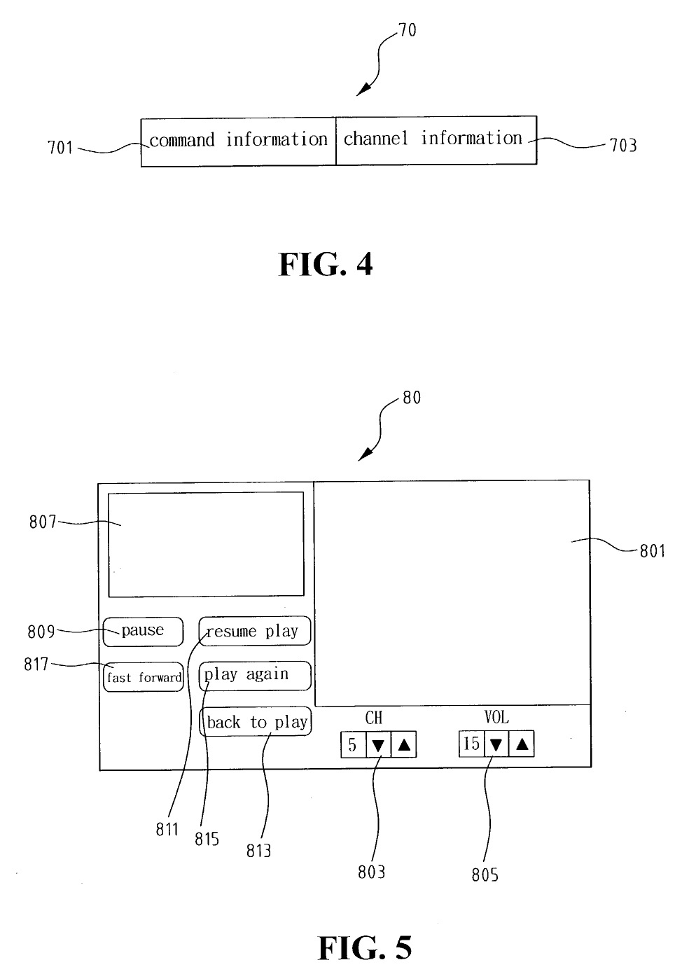

With reference to FIG. 4, the command package 70 includes at least one command information 701 and one channel information 703 related to a corresponding video program over the IP address 121. The command information 701 is used to store a random visual communication order, a pause order, a fast forward order, a random play order, an end order and an order for playing the sequel. The channel information 703 is used to store the channel playing in the user's end electronic device 16 so that with the provision of the command package 70, the user is able to freely control the channel and the playing of the video program.

With reference to FIG. 5, the user's end electronic device 16 is connected to the program broadcasting server 12 through the internet 20. The area 801 in the screen 80 shows the current video program. Area 803 shows the current channel and the channel switch. Area 805 shows the current volume and the adjust of the volume. Area 807 shows related information of the current video program, such as the name of the video program and a brief introduction of the video program. Area 809 to area 817 provide input of commands.

The advantage of the present invention comprises:

1. Each IP address 121 corresponds to different video programs in one channel and combines random visual communication function so as to allow the user to enjoy completeness of watching a program;

2. The end user is able to save cost buying devices to adapt to this system because the user is able to use the PCs available at home; and

3. The method is able allow the user to use the current existing internet, ADSL network and cable network without spending additional expenses in setting new equipment.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for asynchronously watching programs from internet by using a program broadcasting server, a random visual communication server and user's end electronic devices, the method comprising the steps of:
in program broadcasting server:
providing at least one IP address in connection to the internet, wherein the at least one IP address represents corresponding programs;
receiving a user's end connection through the at least one IP address; and
transmitting the corresponding programs through the at least one IP address to the user's end;
in the random visual communication server:
receiving the user's end connection to the random visual communication server;
receiving command package to the random visual communication server from the user's end; and
processing the command package by the random visual communication server;
in the user's end electronic device:
the user's end requesting connection to the video program broadcasting server;
receiving programs of the video program broadcasting server through the IP address;
the user's end playing the received programs;
sending command package from the user's end to the random visual communication server;
receiving responses from the random visual communication server after sending the command package; and
playing the visual programs as randomly selected by the user's end electronic device.

2. The method as claimed in claim 1, wherein the program is a digital video program.

3. The method as claimed in claim 1, wherein the command package comprises at a command information and a channel information corresponding to the at least one IP address.

4. The method as claimed in claim 3, wherein the command information includes a play command, a pause command, a fastforward command, an end playing command and a sequel command.

5. The method as claimed in claim 1, wherein the user's end electronic device is a personal computer which has a central processing unit, a memory and an internet interface.

6. The method as claimed in claim 1, wherein the user's end electronic device is a set top box which has a central processing unit, a memory and an internet interface.

7. The method as claimed in claim 1, wherein the program broadcast server comprises at one central processing, a memory, a program information bank and an internet interface, wherein the program information bank is used to store multiple video programs to be transmitted through the IP address.

8. The method as claimed in claim 1, wherein the random visual communication server comprises at one central processing, a memory, a program information bank and an internet interface, wherein the program information bank is used to store multiple video programs to be selected.

9. A system for asynchronously watching programs from the internet, a random visual communication server and user's end electronic devices, the system comprising:
a program broadcasting server which has:
at least one IP address connected to the internet, wherein the IP address represents a corresponding video program channel;
a central processing unit, a memory, a program information bank and an internet interface, wherein the program information bank is used to store multiple video programs over the IP address;
whereby the central processing unit is able to process program codes stored in the memory, the program codes enable the program broadcasting server to receive the connection from the user's end electronic devices to the IP address and retrieve sequentially programs from the program information bank and then transmit the retrieved programs to the user's end electronic devices, the internet interface enables the program broadcasting server to connect to the internet;
a random visual communication server, which has:
a central processing unit which is able to process the program codes stored in a memory so that the random visual communication server is able to receive, process and respond to a command package from the user's end electronic devices;
a video program bank which is used to store multiple randomly selected video programs; and
an internet interface which enables the random visual communication server to connect to the internet; and
user's end electronic devices which comprises:
a central processing unit enabling to process program codes stored in memory; and
an internet interface enabling the user's end electronic devices to connect to the internet;
whereby the user's end electronic devices are able to receive and play video programs form the program broadcasting server;
the user's end electronic devices are able to send command package to the random visual communication server and then receive responses from the random visual communication server to the command package.

10. The system as claimed in claim 9, wherein the command package includes at least one command information and a channel information corresponding to the at least one IP address.

11. The system as claimed in claim 10, wherein the command information is composed of a play command, a pause command, a fast forward command, an end playing command and a sequel command.

12. The system as claimed in claim 9, wherein the multiple video programs stored in the program information bank of the program broadcasting server are bit stream video programs.

13. The system as claimed in claim 9, wherein the multiple randomly selected video programs stored in the program information bank of the random visual communication server are bit stream video programs.
